(19) United States
(12) Patent Application Publication
(10) Pub. No.: US 2004/0043131 A1
(43) Pub. Date: Mar. 4, 2004

(54) Food product for animals

(75) Inventor: Kiyoshi Fumita, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: KABUSHIKI KAISHA TOMINAGA JYUSHI KOGYOSHO, Higashiosakashi (JP)

(21) Appl. No.: 10/353,956

(22) Filed: Jan. 30, 2003

(30) Foreign Application Priority Data
Aug. 29, 2002 (JP) 2002-250981

(51) Int. Cl. A23L 1/325

(52) U.S. Cl. 426/643

(57) ABSTRACT

The present invention provides a food product for animals, which has sufficient hardness, and strongly interests the animals, and the animals bite and eat it well. In addition, the food product of the present invention is nutritious to the animals. According to the present invention, there is provided a food product for animals comprising a mixture composition comprising a fish ingredient and a starch. In the mixture composition, the fish ingredient is contained in an amount of 5 to 70% by weight, and the starch is contained in an amount of 5 to 95% by weight. Also, water is added to the mixture composition to be formed into the product having a pre-determined shape. According to the present invention, water is contained in the food product in an amount of 10 to 40% by weight.

### FIELD OF THE INVENTION

The present invention relates to a food product for animals, and especially to the same which has a sufficient hardness and is nutritious for the animals, and which interests the animals such that they chew and eat it well. In particular, the present invention is used as a chew toy for animals like dogs.

### RELATED ART

Conventionally, a chew toy or chew bone is used, which is prepared by the following steps: drying a cowhide (raw hide), finely milling it, and then forming it into a shape like a bone.

Also, a chew toy or chew bone for animals is known which includes a starch and a decomposable ethylene copolymer, or which is made of a synthetic resin, such as polyethylene, nylon resin and urethane resin, and which is prepared by means of injection molding.

These conventional chew toys or chew bones have an appropriate hardness, and therefore, they are helpful for animals to obtain a teeth brushing effect or to obtain a teeth strengthening effect when the animals such as dogs chew the chew toys or chew bones, resulting in maintenance of the health of the animals.

### OBJECTIVES TO BE SOLVED BY THE INVENTION

However, the conventional chew toys or chew bones have the following problems: Since the former type of the chew toys is made of a cowhide, it is limited as to variety of shape. On the other hand, the latter type of chew toys, when accidentally swallowed, may be considered to be unsafe, or may cause anxiety with respect to health since resin is included.

The present invention was invented with consideration of such technical background, and provides a novel food product for animals, which has a sufficient hardness and interests animals so as to be likely to chew and eat it, and which is also nutritious for animals.

According to the present invention, there is provided a food product for animals comprising,

a mixture composition comprising a fish ingredient and a starch,

wherein in the mixture composition, the fish ingredient is contained in an amount of 5 to 70% by weight, and the starch is contained in an amount of 5 to 95% by weight, and wherein water is added to the mixture composition to be formed into the product having a pre-determined shape, and wherein water is contained in the food product in an amount of 10 to 40% by weight.

The food product for animals according to the present invention is defined to include the fish ingredient and starch in the specified amounts, resulting in having a sufficient hardness. Therefore, the food product of the present invention accomplishes a teeth brushing effect and teeth strengthening effect, and thereby keeps the teeth of the animal healthy. Also, the food product of the present invention includes a fish ingredient, thereby making animals like dogs interested in such that the animals will actively chew and eat it. In addition, the food product according to the present invention includes starch and fish ingredient, resulting in being nutritious for the animals and helpful in keeping them healthy. Also, the food product according to the present invention includes no resin ingredients, resulting in avoiding the animals from being unhealthy.

According to the second aspect of the present invention, there is provided a food product for animals comprising,

a mixture composition comprising a fish ingredient, a starch and an extending agent,

wherein in the mixture composition, the fish ingredient is contained in an amount of 5 to 70% by weight, and the starch is contained in an amount of 5 to 70% by weight, and the extending agent is contained in an amount of more than 0 to 75 wt %, and wherein water is added to the mixture composition to be formed into the product having a pre-determined shape, and wherein water is contained in the food product in an amount of 10 to 40% by weight.

The food product for animals according to the present invention is defined to include fish ingredient, starch, and extending agent in the specified contents, resulting in having a sufficient hardness. Therefore, the food product of the present invention accomplishes a teeth brushing effect and teeth strengthening effect, and thereby keeps the animal's teeth healthy. Also, the food product of the present invention includes fish ingredient, and thereby the animals like dogs are interested it in, so that the animals will actively chew and eat it. In addition, the food product according to the present invention includes a starch and fish ingredient, resulting in being nutritious for animals and helpful in keeping them healthy. Also, the food product according to the present invention includes no resin ingredients, resulting in avoiding the animals from being unhealthy. Furthermore, the food product of the present invention may decrease the cost of production because of including an extending agent, which may be obtained at a low cost.

In the case of the second aspect of the present invention, the extending agent may be at least one selected from the group consisting of tofu refuse and rice bran. Tofu refuse and rice bran are commercially available at a low price, so that the production cost of the food product may be reduced. In addition, these materials include many nutrients, which are important in view of nutritional science, resulting in keeping animals healthy.

Among the group listed above, it is especially preferable to use tofu refuse as the extending agent. The food product including tofu refuse is extremely interesting to animals.

According to the present invention, the starch may be at least one selected from the group consisting of corn starch, wheat starch, tapioca starch, and potato starch. By using such starches, the food product of the invention may be formed into various shapes because of increasing its formability.

Among the group listed above, corn starch is preferably used. By using corn starch, the food product of the present invention may obtain a sufficient hardness and strength.

Furthermore, the starch may be corn starch in combination with at least one selected from the group consisting of wheat starch, tapioca starch, and potato starch. In this modification, corn starch is included as an essential ingredient, and the food product is given a sufficient hardness and strength.

According to the third aspect of the present invention, there is provided a food product for animals comprising,

a mixture composition comprising a fish ingredient, corn starch and wheat starch,

wherein in the mixture composition, the fish ingredient is contained in an amount of 5 to 70% by weight, and corn starch is contained in an amount of 20 to 85% by weight, and wheat starch is contained in an amount of 5 to 75% by weight, and wherein water is added to the mixture composition to be formed into the food product having a pre-determined shape, and wherein water is contained in the food product in an amount of 10 to 40%by weight.

The food product for animals according to the present invention is defined to include fish ingredient, corn starch, and wheat starch, in the specified amounts, resulting in having a sufficient hardness. Therefore, the food product of the present invention accomplishes a teeth brushing effect and teeth strengthening effect, and thereby keeps the animal's teeth healthy. Also, the food product of the present invention includes fish ingredient, and thereby animals like dogs are interested it in, so that the animals will actively chew and eat it. In addition, the food product according to the present invention includes corn starch, wheat starch and fish ingredient, resulting in being nutritious for animals and helpful in keeping them healthy. Further, addition of corn starch makes the food product to have strength and hardness to a sufficient extent, and addition of wheat starch makes a homogenized pre-formed material so as to stabilize the quality of the final product. Also, the food product according to the present invention includes no resin ingredients, and thereby, it avoids the animals from being bad healthy.

According to the fourth aspect of the present invention, there is provided a food product for animals comprising,

a mixture composition comprising a fish ingredient, corn starch, wheat starch, and tofu refuse,

wherein in the mixture composition, the fish ingredient is contained in an amount of 5 to 70% by weight, and corn starch is contained in an amount of 0.1 to 85% by weight, and wheat starch is contained in an amount of 5 to 75% by weight, and tofu refuse is contained in an amount of 5 to 75% by weight, and wherein water is added to the mixture composition to be formed into the food product having a pre-determined shape, and wherein water is contained in the food product in an amount of 10 to 40% by weight.

The food product for animals according to the present invention is defined to include fish ingredient, corn starch, wheat starch, and tofu refuse, in the specified amounts, resulting in having a sufficient hardness. Therefore, the food product of the present invention accomplishes a teeth brushing effect and teeth strengthening effect, thereby keeping the animal's teeth healthy. Also, the food product of the present invention includes fish ingredient, and thereby, animals like dogs are interested it in, so that animals will actively chew and eat it. In addition, the food product according to the present invention includes fish ingredient, corn starch, wheat starch and tofu refuse, which are important in nutritious science, resulting in being nutritious for animals and helpful in keeping them healthy. Further, addition of corn starch makes the food product to have enough strength and hardness to a sufficient extent, and addition of wheat starch makes a homogenized pre-formed material so as to stabilize the quality of the final product. Furthermore, addition of tofu refuse makes the food product strongly interest the animals. In this respect, dogs are significantly interested in the food product according to this aspect. Also, the food product according to the present invention includes no resin ingredients, thereby resulting in avoiding animals from being unhealthy. The food product according to the present invention preferably includes tofu refuse in an amount larger than that of corn starch, such that the removability of the food product from the mold used to form it may be increased, which is beneficial. Thus, the efficiency of the preparation of the food product as well as the appearance thereof may be increased, so as to prepare it in a high quality.

According to the present invention, a sardine may be used as the fish ingredient, thereby making animals such as dogs are strongly interested in the food product of the present invention, such that they chew and eat more thoroughly.

According to the present invention, with respect to the fish ingredient, a treated residue of heads, bones, guts thereof may be used. When processing the fish, these portions of the fish generally remains, and disposed of as non-eaten parts. By using these portions, such wastes may be recycled and reduced efficiently, and in addition, these portions may be available at a low price so as to reduce the cost of the producing of the food product. Also, since the heads of the fish are rich in DHA (highly unsaturated fatty acid), and the bones are rich in calcium. Therefore, both of these portions are helpful for the development of animals.

The food product of the present invention may be formed by means of injection molding, which assures a desirable and sufficient strength and hardness. Also, injection molding may be beneficial to form the food product in various shapes.

According to the present invention, the food product may be preferably formed into a shape the same as, or similar to, a bone of an animal, so as to be used as a chew toy for the animals. By forming into a shape the same as, or similar to, an animal's bone, the animals such as dogs are strongly interested in the food product. In addition, such shape avoids generating any portions insufficient in strength, resulting in being appropriate for chew toys for the animals.

According to the present invention, the food product may preferably include water in an amount of 15 to 35% by weight. Thereby, the food product may have a sufficient strength with increasing its formability.

### BRIEF DESCRIPTION OF THE DRAWING

FIG. 1 shows a perspective view of the food product for animals as one embodiment of the present invention.

### EMBODIMENTS

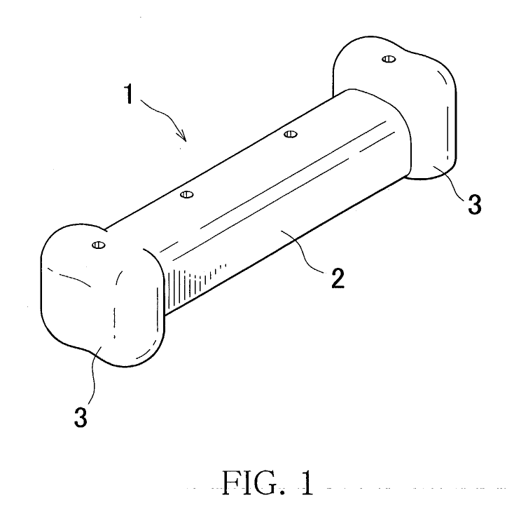

FIG. 1 shows an embodiment of the food product for animals according to the present invention. The shown food product for animals (1) comprises a bar-shaped body (2), both ends of which have swelled portions (3), (3). The food product is formed by means of injection molding to obtain a shape like an animal's bone.

The food product (1) for animals shown as the embodiment comprises a mixture composition comprising a fish ingredient and a starch, wherein in the mixture composition, the fish ingredient is contained in an amount of 5 to 70% by weight, and the starch is contained in an amount of 5 to 95% by weight, and wherein water is added to the mixture composition to be formed into the product having a pre-determined shape, and wherein water is contained in the food product in an amount of 10 to 40% by weight. (The first aspect of the present invention) It is noted that the “content of water” means to include all of the water, which is contained in the fish ingredient and starch, in addition to the added one during the forming.

The food product (1) for animals is defined to include fish ingredient and starch in the specified amounts, thereby resulting in having a sufficient hardness. Therefore, the food product accomplishes a teeth brushing effect and teeth strengthening effect, thereby keeping the animal's teeth healthy. Also, the food product includes fish ingredient, and thereby animals like dogs are interested it in, so that animals will actively chew and eat it. In addition, the food product includes a starch and fish ingredient, resulting in being nutritious for animals and helpful in keeping them healthy. Also, the food product includes no resin ingredients, and thereby, it avoids the animals from being bad healthy.

Where the content of fish ingredient is less than the lower limit, defined in the present invention, the animals would be less interested in the food product. On the other hand, where the content of the fish ingredient is more than the upper limit, defined in the present invention, the food product would not have a sufficient hardness. Also, if the content of the starch is less than the lower limit, defined in the present invention, the product would have an insufficient hardness. On the other hand, the content of the starch is more than the upper limit, defined in the present invention, the animals would be less interested in the food product. Also, if the content of water is less than the lower limit, defined in the present invention, the mixture composition would have a less homogeneity, resulting in having less strength. On the other hand, if the content of water is more than the upper limit, defined in the present invention, the composition in the pre-formed condition would reduce its viscosity, thereby resulting in bad formability.

Alternatively, the food product for animals may comprise a mixture composition comprising a fish ingredient, a starch and an extending agent, wherein in the mixture composition, the fish ingredient is contained in an amount of 5 to 70% by weight, and the starch is contained in an amount of 5 to 70% by weight, and the extending agent is contained in an amount of more than 0 to 75% by weight, and wherein water is added to the mixture composition to be formed into the product having a pre-determined shape, and wherein water is contained in the food product in an amount of 10 to 40% by weight. (The second aspect of the present invention) In the second aspect of the present invention, the same effect is expected as the case of the first aspect. In addition, since the extending agent used in the second aspect is low price, thereby resulting in reducing the cost.

In the second aspect of the present invention, where the content of the fish ingredient is less than the lower limit, defined in the present invention, the animals would be less interested in the food product. On the other hand, where the content of the fish ingredient is more than the upper limit, defined in the present invention, the food product would not have a sufficient hardness. Also, where the content of the starch is less than the lower limit, defined in the present invention, the product would have an insufficient hardness. On the other hand, where the content of the starch is more than the upper limit, defined in the present invention, the food product would be too hard. Also, the content of water is less than the lower limit, defined in the present invention, the mixture composition would have a less homogeneity, resulting in less strength. On the other hand, where the content of water is more than the upper limit, defined in the present invention, the composition in the pre-formed condition would reduce its viscosity, thereby resulting in bad formability.

In the second aspect of present invention, it is preferably that the food product for animals may comprise a mixture composition comprising a fish ingredient, a starch and an extending agent, wherein in the mixture composition, the fish ingredient is contained in an amount of 10 to 60% by weight, and the starch is contained in an amount of 10 to 60% by weight, and the extending agent is contained in an amount of more than 0 to 60 wt %, and wherein water is added to the mixture composition to be formed into the product having a pre-determined shape, and wherein water is contained in the food product in an amount of 10 to 40% by weight.

The extending agent is not limited to the present invention, but it is preferable to use at least one selected from the group consisting essentially of tofu refuse and rice bran. Tofu refuse and rice bran may be available at a low price, so as to reduce the cost of the producing. In addition, tofu refuse and rice bran include many nutrition which is important in nutritious science, thereby keeping animals healthy.

Among the group listed above, it is preferable to use tofu refuse as the extending agent. The food product including tofu refuse may further interest the animals. Especially, dogs are significantly interested in the food product.

As the fish used in the present invention, any kind of fish may be used. The fish used may include sardine, horse mackerel, saury, tuna, sea bream, salmon, bonito, yellowtail, flounder, globefish, eel, sea eel, sweetfish, carp, cuttlefish, octopus, and the like, but the present invention may not be not limited thereto. Among the group listed above, sardine is preferably used as the fish ingredient, and thereby, animals such as dogs are strongly interested in the food product, and will preferably chew and eat it.

According to the present invention, all of the portions of the fish may be used. Especially, the middle bodies, heads, bones, guts and fins of the fish, as well as the residue after processing the fish may be used. The portions of the fish may be used alone or in combination therewith. Alternatively, the present invention may use the whole of the fish.

Among the portions listed above, it is preferable to use at least one selected from the group consisting of heads, bones, guts, and the residue after processing the fish. These portions remains after processing the fish, and generally disposed of as non-eaten parts. By using these portions, wastes may be recycled and reduced efficiently, and in addition, these portions may be available at a low price so as to reduce the cost of the producing of the food product.

According to the present invention, the starch may be at least one selected from the group consisting of corn starch, wheat starch, tapioca starch, and potato starch. Using such starches may make the food product in a good formability. In addition, the potato starch may include sweet potato starch, and white potato starch.

Among the group listed above, it is preferable to use corn starch (maize starch) as the starch ingredient to be included. Such food product may have a sufficient hardness and strength.

In case of using corn starch as the starch, it is preferable that the food product (1) for animals of the embodiment comprises a mixture composition comprising a fish ingredient, corn starch and wheat starch, wherein in the mixture composition, the fish ingredient is contained in an amount of 5 to 70% by weight, and corn starch is contained in an amount of 20 to 85% by weight, and wheat starch is contained in an amount of 5 to 75% by weight, and wherein water is added to the mixture composition to be formed into the food product having a pre-determined shape, and wherein water is contained in the food product in an amount of 10 to 40% by weight.

The food product for animals of the embodiment is defined to include fish ingredient, corn starch, and wheat starch, in the specified amounts, resulting in having a sufficient hardness. Also, addition of corn starch makes the food product to have strength and hardness to the sufficient extent, and addition of wheat starch makes a homogenized pre-formed material so as to stabilize the quality of the final product.

Further, in case of including corn starch as the starch ingredient, it is preferable that the food product for animals of the embodiment comprises a mixture composition comprising fish ingredient, corn starch, wheat starch, and tofu refuse, wherein in the mixture composition, the fish ingredient is contained in an amount of 5 to 70% by weight, and corn starch is contained in an amount of 0.1 to 85% by weight, and wheat starch is contained in an amount of 5 to 75% by weight, and tofu refuse is contained in an amount of 5 to 75% by weight, and wherein water is added to the mixture composition to be formed into the food product having a pre-determined shape, and wherein water is contained in the food product in an amount of 10 to 40% by weight.

The food product for animals of the embodiment is defined to include fish ingredient, corn starch, wheat starch, and tofu refuse, in the specified amounts, thereby resulting in having a sufficient hardness. Also, addition of corn starch makes the food product to have strength and hardness to the sufficient extent, and addition of wheat starch makes a homogenized pre-formed material so as to stabilize the quality of the final product. Furthermore, addition of tofu refuse makes the food product strongly interest the animals. In this respect, dogs are significantly interested in the food product according to the aspect.

According to the present invention, it is preferable to include water in the food product in an amount of 15 to 35% by weight. Where the food product includes water less than the lower limit, it may partially decrease the strength due to lack of the homogeneity of the mixture composition in the pre-formed condition. On the other hand, where the food product includes water more than the upper limit, the viscosity of the mixture composition may be decreased, thereby resulting in worse formability.

The mixture composition or food product of the present invention may include other ingredients than fish ingredient, starch, and extending agent. For example, vitamin compound, antioxidation agent, calcium compound may be added.

The order of the incorporation of the ingredients, such as the fish ingredient, starch, extending agent and water, is not limited to the present invention. One method is that all of the ingredients are concurrently mixed together to prepare the mixture composition. Alternatively, some or all ingredients may be added in a specific order. For example, in adding wheat starch, the other ingredients than wheat starch are previously mixed with water, followed by adding wheat starch, to avoid wheat starch from forming small lumps.

It is noted that the embodiment shown in the figure has a shape similar to an animal's bone, but the present invention may not be limited thereto. Alternatively, the food product of the present invention may have a shape like a fish and the like.

It is also noted that the embodiment shown is formed by means of injection molding, but the present invention is not limited thereto. The food product of the present invention may be formed by means of extrusion molding. However, it is preferable to use injection molding, since it assures to give the food product a sufficient strength and hardness.

The food product (1) for animals shown as the embodiment is preferably used as a chew toy for dogs, but the present invention is not limited thereto. For example, it may be used as a chew toy for cats, hamsters, ferrets, and the like.

Also, the food product (1) for animals according to the present invention may be formed into various animal breeding goods, such as vessels and dishes to drink water and feed. The scope of the present invention may encompass such products. Such vessels and dishes for animals according to the present invention may be safe in terms of the health of animals, even if they accidentally swallow and eat the goods. Conventional vessels and dishes, which are made of a synthetic resin, are not always safe and are considered to affect on animal's health if eaten, since they include a resin. However, according to the present invention, there is no need to take it into consideration.

### EXAMPLES

Next, the present invention is explained in detail based on the examples.

### Example 1

Non-eaten portions of sardines which remain after processing them, that were heads, bones, guts, and the other residues thereof, were provided. 35 parts by weight of the non-eaten portions of sardines, 65 parts by weight of corn starch, and 4 parts by weight of water were mixed together to obtain a homogenized composition. Such pre-formed material was subjected to injection molding through a die, so as to obtain a food product for animals as shown in FIG. 1. The weight of the obtained food product was 80 g, approximately.

### Examples 2 to 19, and Comparative Examples 1 and 2

Food products (80 g, approximately) according to Example 2 to 19, and comparative examples 1 and 2, were prepared in the same manner as described in Example 1, with the exception of using the compositions shown in Tables. 1 and 2.

Only the middle portions of horse mackerels were used. The whole body of sauries were used.

With respect to the food products prepared, the interests shown by the animals, hardness, and removability from the mold are estimated. Results are shown in Tables 1 to 4.

TABLE 1

| | | | | Ex. 1 | Ex. 2 | Ex. 3 | Ex. 4 | Ex. 5 | Ex. 6 | Ex. 7 | Ex. 8 |
|---|---|---|---|---|---|---|---|---|---|---|---|
| Pre- | Mixture | Fish | Sardine | 35 | 40 | 30 | 25 | 25 | 20 | 30 | 35 |
| formed | composition | ingred- | Horse mackerel | — | — | — | — | — | — | — | — |
| material/ | | ient | Saury | — | — | — | — | — | — | — | — |
| Parts by | | Starch | Corn starch | 65 | — | — | — | 40 | 30 | 20 | 15 |
| weight | | | Wheat starch | — | 60 | — | — | — | 10 | — | — |
| | | | Tapioca starch | — | — | 70 | — | — | — | 15 | — |
| | | | Potato starch | — | — | — | 75 | — | — | — | 20 |
| | | Extending | Tofu refuse | — | — | — | — | 35 | — | 35 | — |
| | | agent | Rice bran | — | — | — | — | — | 40 | — | 30 |

| | Water | 4 | 5 | 7 | 10 | 5 | 7 | 8 | 10 |
|---|---|---|---|---|---|---|---|---|---|
| Water content in the product (wt %) | | 30 | 32 | 28 | 27 | 25 | 25 | 28 | 30 |
| Evaluation | Interests by dogs | ⊚ | ⊚ | ⊚ | ⊚ | ⊚ | ⊚ | ⊚ | ⊚ |
| | Hardness | D-75 | A-70 | D-60 | D-50 | D-65 | D-60 | D-50 | A-70 |
| | Removability | ⊚ | ⊚ | ⊚ | ⊚ | ⊚ | ⊚ | ⊚ | ⊚ |

Ex.: Example according to the present invention
C. Ex.: Comparative Example

TABLE 2

| | | | | Ex. 9 | Ex. 10 | Ex. 11 | Ex. 12 | Ex. 13 | C. Ex. 1 | C. Ex. 2 |
|---|---|---|---|---|---|---|---|---|---|---|
| Pre- | Mixture | Fish | Sardine | 15 | 15 | 15 | — | — | 80 | — |
| formed | composition | ingred- | Horse mackerel | — | — | — | 15 | — | — | — |
| material/ | | ient | Saury | — | — | — | — | 15 | — | — |
| Parts by | | Starch | Corn starch | 60 | 26 | 34 | 26 | 26 | — | 34 |
| weight | | | Wheat starch | 15 | 15 | 15 | 15 | 15 | — | 15 |
| | | | Tapioca starch | — | — | — | — | — | — | — |
| | | | Potato starch | — | — | — | — | — | — | — |
| | | Extending | Tofu refuse | — | 34 | 26 | 34 | 34 | 20 | 41 |
| | | agent | Rice bran | — | — | — | — | — | — | — |

| | Water | 10 | 10 | 10 | 10 | 10 | 10 | 10 |
|---|---|---|---|---|---|---|---|---|
| Water content in the product (wt %) | | 27 | 25 | 25 | 25 | 25 | 30 | 20 |
| Evaluation | Interests by dogs | ⊚ | ⊚ | ⊚ | ◯ | ◯ | ⊚ | X |
| | Interests by cats | ◯ | ⊚ | ⊚ | ◯ | ◯ | ⊚ | X |
| | Interests by ferrets | ◯ | ⊚ | ⊚ | Δ | Δ | ◯ | X |
| | Hardness | D-75 | D-50 | D-60 | D-50 | D-50 | A-10 | D-50 |
| | Removability | ⊚ | ⊚ | ◯ | ⊚ | ⊚ | ⊚ | ⊚ |

Ex.: Example according to the present invention,
C. Ex.: Comparative Example

TABLE 3

| | | | | Ex. 14 | Ex. 15 | Ex. 16 | Ex. 17 | Ex. 18 | Ex. 19 |
|---|---|---|---|---|---|---|---|---|---|
| Pre- | Mixture | Fish | Sardine | 20 | 20 | 20 | 20 | 20 | 20 |
| formed | composition | ingred- | Horse mackerel | — | — | — | — | — | — |
| material/ | | ient | Saury | — | — | — | — | — | — |
| Parts by | | Starch | Corn starch | 61 | 30 | 38 | 25 | — | — |
| weight | | | Wheat starch | 14 | 7 | 7 | 14 | 14 | 10 |
| | | | Tapioca starch | — | — | — | — | 61 | 30 |
| | | | Potato starch | — | — | — | — | — | — |
| | | Extending | Tofu refuse | — | 38 | 30 | — | — | — |
| | | agent | Rice bran | — | — | — | 35 | — | 35 |

| | Water | 5 | 5 | 5 | 6 | 5 | 5 |
|---|---|---|---|---|---|---|---|
| Water content in the product (wt %) | | 27 | 25 | 25 | 25 | 27 | 25 |
| Evaluation | Interests by dogs | ⊚ | ⊚ | ⊚ | ⊚ | ⊚ | ⊚ |
| | Hardness | D-75 | D-60 | D-65 | D-50 | D-60 | D-50 |
| | Removability | ◯ | ⊚ | ◯ | ⊚ | ◯ | ⊚ |

Ex.: Example according to the present invention, and C. Ex.: Comparative Example

TABLE 4

| Evaluation of the interests by dogs | Ex. 9 | Ex. 10 |
|---|---|---|
| A hybrid, 1 year old | 3 | 5 |
| A hybrid, 7 years old | 3 | 4 |
| A golden retriever, 1.5 years old | 4 | 5 |
| A shiba, 10.5 years old | 5 | 5 |
| A beagle, 4 years old | 3 | 4 |
| A hybrid of collie, 7 years old | 3 | 4 |
| A shetland sheepdog, 5 years old | 3 | 5 |
| A beagle, 5 years old | 5 | 5 |

<Estimation of Hardness>

In accordance with JIS K6253, hardness of the food product are measured by using an A type or D type durometer.

<Estimation of Removability>

Removability was estimated in removing the food product from the mold after subjecting it to injection molding. When it was removed from the mold in a good manner, the estimation of “⊚” was given. When it was removed from the mold in a relatively good manner, the estimation of “◯” was given. When it was removed from the mold in a bad manner, the estimation of “X” was given.

<Estimation of Interests by Dogs>

Estimation of “⊚” was given when all kinds of the dogs finished eating the food product within one hour. Estimation of “◯” was given when almost all kinds of the dogs finished eating the food product within one hour. Estimation of “Δ” was given when some kinds of the dogs finished eating the food product within one hour. Estimation of “X” was given when neither the dogs finished eating the food product within one hour.

In addition, detailed estimation of the interests shown by the dogs with respect to Examples 9 and 10 are shown in Table 4 in detail. The standard of the estimation in Table 4 is as follows: “5” was given when the dogs finished eating the food product within less than 20 minutes. “4” was given when the dogs finished eating the food product within 20 to 40 minutes. “3” was given when the dogs finished eating the food product within 40 to 60 minutes. “2” was given when the dogs finished eating the food product within 1 to 12 hours. “1” was given when the food product was remained after 12 hours.

<Estimation of the Interests Shown by Cats and Ferrets>

Estimation of “⊚” was given when being finished eating the food product within one hour. Estimation of “◯” was given when being finished eating the food product within one to three hours. Estimation of “Δ” was given when being finished eating the food product within three to 12 hours. Estimation of “X” was given when the food product was remained after 12 hours, or when animals showed no interests to the food product. It is noted that each food product was fed in an amount of 20 g in this test.

As shown in Tables 1 to 4, the food products prepared according to Examples 1 to 19 have enough hardness, so that they would not be broken without resistance, and would provide a good teeth brushing effect and be interesting to animals. Also, they show a good removability from the mold.

Also, as shown in the comparison of Example 9 with Example 10 (See Table 4), Example 10, including tofu refuse, provides an especially good interests shown by animals.

On the other hand, Comparative Example 1 had insufficient hardness, showing that it broke without resistance when the animals bitten it. Also, Comparative Example 2 had sufficient hardness, but it was inferior to the interests shown by the animals.

According to the inventions defined by claims 1 and 10, the food product has sufficient hardness, which provides a teeth brushing effect, resulting in keeping the animal's teeth in a good condition. Since the food product according to the present invention includes a fish ingredient, animals such as dogs are well interested in the food product, and they would actively chew and eat the food product. Since the food product according to the present invention includes a starch and fish ingredient, which are nutritious for animals, it is beneficial to the animal's health. Also, the food product of the present invention includes no resin composition, it would less cause animals unhealthy.

According to the invention defined by claim 11, the food product will reduce the cost, in addition to the effects as described above. Especially, tofu refuse and rice bran include many nutrients which are important in nutritious science, and thereby they contribute to the animal's health.

According to the invention defined by claim 12, the food product strongly interests animals, in addition to the effect as described above.

According to the invention defined by claims 2 and 13, the food product has the increased formability, in addition to the effect as described above.

According to the invention defined by claims 3, 14, the food product is beneficial in obtaining further sufficient hardness and strength in the food product, in addition to the effect as described above.

According to the invention defined by claims 4 and 15, the food product is beneficial in obtaining further sufficient hardness and strength in the food product, in addition to the effect as described above.

According to the inventions defined by claims 21 and 26, the food product has sufficient hardness, which provides a teeth brushing effect, thereby resulting in maintenance of the animal's teeth healthy. Since the food product according to the present invention includes a fish ingredient, animals such as dogs are well interested in the food product, and they would actively chew and eat the food product. Since the food product according to the present invention includes corn starch, wheat starch and fish ingredient, which are nutritious for the animals, it is beneficial for the animal's health. Addition of corn starch makes the food product to have sufficient hardness and strength, and also, addition of wheat starch makes the forming material homogenized, so as to produce the food product in a standardized quality. Also, the food product of the present invention includes no resin composition, thereby resulting in less causing animals unhealthy.

According to the invention defined by claim 26, the food product interests animals since it includes tofu refuse, in addition to the effect as described above.

According to the invention defined by claim 27, the food product is beneficial in increasing the removability during the forming of the product, in addition to the effect as described above, and thereby, the productivity of the food product is increased, and the appearance and quality thereof are improved.

According to the invention defined by claims 5, 16, 22, and 28, the food product strongly interests animals such as dogs, in addition to the effect as described above, and it would be chewed and eaten better.

According to the invention defined by claims 6, 17, 23, and 29, the food product is beneficial in recycling the waste of the industrially processed fishes, in addition to the effect as described above, thereby resulting in reducing the volume of the waste to be disposed of. Also, it is beneficial in the cost of the product.

According to the invention defined by claims 7, 18, 23, and 30, the food product is beneficial, in addition to the effect as described above, in assuring to produce the food product having a predeteremined strength and hardness.

According to the invention defined by claims 8, 19, 24, and 31, the food product further interests animals such as dogs, in addition to the effect as described above. In addition, it has no insufficient portion in strength, and it is preferable to be used as a chew toy of the animals.

According to the invention defined by claims 9, 20, 25, and 32, the food product is beneficial, in addition to the effect as described above, in assuring to produce the food product having a sufficient strength and formability.

What is claimed is:

1. A food product for animals comprising,
a mixture composition comprising a fish ingredient and a starch,
wherein in the mixture composition, the fish ingredient is contained in an amount of 5 to 70% by weight, and the starch is contained in an amount of 5 to 95% by weight, and wherein water is added to the mixture composition to be formed into the product having a pre-determined shape, and wherein water is contained in the food product in an amount of 10 to 40% by weight.

2. A food product for animals according to claim 1, wherein the starch is at least one selected from the group consisting of corn starch, wheat starch, tapioca starch, and potato starch.

3. A food product for animals according to claim 1, wherein the starch is corn starch.

4. A food product for animals according to claim 1, wherein the starch is a combination of corn starch and at least one selected from the group consisting of wheat starch, tapioca starch, and potato starch.

5. A food product for animals according to claim 1, wherein the fish ingredient is from a sardine.

6. A food product for animals according to claim 1, wherein as the fish ingredient, a processed residue of heads, bones, guts thereof is used.

7. A food product for animals according to claim 1, wherein the food product is formed by means of injection molding.

8. A food product for animals according to claim 1, wherein the food product is formed into a shape the same as, or similar to, a bone of an animal, so as to be used as a chew toy for animals.

9. A food product for animals according to claim 1, wherein water is contained in an amount of 15 to 35% by weight in the food product.

10. A food product for animals comprising,
a mixture composition comprising a fish ingredient, a starch and an extending agent,
wherein in the mixture composition, the fish ingredient is contained in an amount of 5 to 70% by weight, and the starch is contained in an amount of 5 to 70% by weight, and the extending agent is contained in an amount of more than 0 to 75 wt %, and wherein water is added to the mixture composition to be formed into the product having a pre-determined shape, and wherein water is contained in the food product in an amount of 10 to 40% by weight.

11. A food product for animals according to claim 10, wherein the extending agent is at least one selected from the group consisting of tofu refuse and rice bran.

12. A food product for animals according to claim 10, wherein the extending agent is tofu refuse.

13. A food product for animals according to claim 10, wherein the starch is at least one selected from the group consisting of corn starch, wheat starch, tapioca starch, and potato starch.

14. A food product for animals according to claim 10, wherein the starch is corn starch.

15. A food product for animals according to claim 10, wherein the starch is a combination of corn starch and at least one selected from the group consisting of wheat starch, tapioca starch, and potato starch.

16. A food product for animals according to claim 10, wherein the fish ingredient is from a sardine.

17. A food product for animals according to claim 10, wherein as the fish ingredient, a processed residue of heads, bones, and guts thereof is used.

18. A food product for animals according to claim 10, wherein the food product is formed by means of injection molding.

19. A food product for animals according to claim 10, wherein the food product is formed into a shape the same as, or similar to, a bone of an animal, so as to be used as a chew toy for the animals.

20. A food product for animals according to claim 10, wherein water is contained in an amount of 15 to 35% by weight in the food product.

21. A food product for animals comprising,
a mixture composition comprising a fish ingredient, corn starch and wheat starch,
wherein in the mixture composition, the fish ingredient is contained in an amount of 5 to 70% by weight, and corn starch is contained in an amount of 20 to 85% by weight, and wheat starch is contained in an amount of 5 to 75% by weight, and wherein water is added to the mixture composition to be formed into the food product having a pre-determined shape, and wherein water is contained in the food product in an amount of 10 to 40% by weight.

22. A food product for animals according to claim 21, wherein the fish ingredient is from a sardine.

23. A food product for animals according to claim 21, wherein as the fish, a processed residue of heads, bones, and guts thereof is used.

24. A food product for animals according to claim 21, wherein the food product is formed by means of injection molding.

25. A food product for animals according to claim 21, wherein the food product is formed into a shape the same as, or similar to, a bone of an animal, so as to be used as a chew toy for the animals.

26. A food product for animals according to claim 21, wherein water is contained in an amount of 15 to 35% by weight in the food product.

27. A food product for animals comprising,
a mixture composition comprising a fish ingredient, corn starch, wheat starch, and tofu refuse,
wherein in the mixture composition, the fish ingredient is contained in an amount of 5 to 70% by weight, and corn starch is contained in an amount of 0.1 to 85% by weight, and wheat starch is contained in an amount of 5 to 75% by weight, and tofu refuse is contained in an amount of 5 to 75% by weight, and wherein water is added to the mixture composition to be formed into the food product having a pre-determined shape, and wherein water is contained in the food product in an amount of 10 to 40% by weight.

28. A food product for animals according to claim 27, wherein the content of tofu refuse is larger than that of corn starch.

29. A food product for animals according to claim 27, wherein the fish ingredient is from a sardine.

30. A food product for animals according to claim 27, wherein as the fish ingredient, a processed residue of heads, bones, and guts thereof is used.

31. A food product for animals according to claim 27, wherein the food product is formed by means of injection molding.

32. A food product for animals according to claim 27, wherein the food product is formed into a shape the same as, or similar to, a bone of an animal, so as to be used as a chew toy for the animals.

33. A food product for animals according to claim 27, wherein water is contained in an amount of 15 to 35% by weight in the food product.
